(19) United States
(12) Patent Application Publication
(10) Pub. No.: US 2013/0199240 A1
(43) Pub. Date: Aug. 8, 2013

(54) METHOD AND SYSTEM FOR DEWATERING AND PREHEATING MIXTURES FOR GLASS MELTING PLANTS

(71) Applicants: Matthias Lindig, Ingelheim (DE); Lothar Rott, Lohr am Main (DE); Karl Bonfig, Waldbrunn (DE); Volker Mûller, Tettau (DE)

(72) Inventors: Matthias Lindig, Ingelheim (DE); Lothar Rott, Lohr am Main (DE); Karl Bonfig, Waldbrunn (DE); Volker Mûller, Tettau (DE)

(73) Assignee: BETEILIGUNGEN SORG GMBH & CO. KG, Lohr am Main (DE)

(21) Appl. No.: 13/511,613

(22) PCT Filed: Nov. 9, 2010
(86) PCT No.: PCT/EP10/06812

§ 371 Date: Oct. 1, 2012

(30) Foreign Application Priority Data
Nov. 24, 2009 (DE) 10 2009 054 354.6

(51) Int. Cl. C03B 3/02

(52) U.S. Cl. CPC C03B 3/023
USPC 65/29.16; 65/136.1; 65/134.6; 65/356; 65/160

(57) ABSTRACT

A method and a system for thermal dewatering and preheating aqueous mixtures for feeding glass melting plants when passing through a shaft-like container provided with heating elements disposed one above another in tiers. To avoid the feed material from becoming glued together or agglomerating in the preheaters while the feed material is heated by exhaust gases with separately guided exhaust gases and feed material, a) the uppermost tier heating elements are closed relative to the mixture and are kept above 100 C, b) the interface between the mixture and the atmosphere above the mixture is shaped and heated by the uppermost tier heating elements so that part of the thermal output is emitted to the atmosphere via the mixture, and c) as the mixture proceeds through the container it is heated by further heating elements to temperatures close to the glass melting plant feeding temperature.

The present invention relates to a method for thermal dewatering and preheating of aqueous mixtures for feeding glass melting plants during passage through a shaft-type container provided with heating elements disposed one over the other in tiers for the supply of heat.

In the area of glass melting technology, it has long been sought to prevent the gluing together of feed material, usually in the form of glass mixtures and glass fragments, during preheating by the exhaust gases of the glass melting plant. However, it has turned out that at the latest after a certain operating duration such a gluing together does occur, interrupting continuous operation. By guiding the smoke gases and the feed material in separate shafts or pipes, the aqueous smoke gas can be prevented from coming into contact with the feed material. Here, shafts or pipes have been used that are disposed in parallel or in intersecting grid structures. However, it has turned out that here as well the feed material still becomes glued together.

Trials have shown that in the case of large amounts of bulk material the gluing together or agglomeration of the feed material takes place above the area of the uppermost smoke gas guide, going out from the container wall of the preheater. Clearly, this was caused by water that repeatedly penetrated into the preheater and/or was carried in by the feed material, either in the form of carried-along moist air in the feed material or in the form of free or bound water in the feed material, which at least partly also has hygroscopic properties.

Anhydrous soda is a component frequently used in the feed material. Below 32° C., the decahydrate (Na₂CO₃10H₂O) is stable. Above 32° C., the decahydrate is transformed into heptahydrate (Na₂CO₃7H₂O) with release of 3H₂O. Above 35° C., the heptahydrate is transformed into monohydrate (Na₂CO₃1H₂O) with release of 6H₂O. Above 105° C., the monohydrate releases the water of crystallization and is converted at least partly into a different crystal structure (cubic). The hydrate formation (adsorption of water of crystallization) is exothermic, and the release is again endothermic. The exothermic conversion can be clearly measured during the mixing process. With the addition of approximately 18% soda and 10% water, the temperature in the mixture increases from approximately 25° C. to approximately 40° C. This heating conflicts with the hydration. The exiting moisture from the mixture is palpable and can be regarded as a cause of the gluing together of the mixture.

DE 10 2008 030 161 B3 discloses a shaft-type heat exchanger for preheating particulate glass mixtures for glass melting ovens, through which smoke gases from the heating of the oven are conducted in alternating, meandering horizontal smoke gas channels. The heat exchanger has numerous channels for the melt material that are vertical and rectangular in cross-section and that—offset transversely—intersect with the smoke gas channels and are connected to one another by openings in the channel walls in a manner intended to suction water vapor out from the vertical melt material channels in the transverse direction and to prevent the entry of smoke gases into the melt material channels. However, it cannot be excluded that, due to the distances between the stated openings in the shaft walls and due to the long horizontal flow paths within the melt material, moisture remains in the melt material, causing gluing together of the particles of the melt material and causing blockage of the supply.

The present invention is therefore based on the object of indicating a method and a device with which it is possible to heat the feed material of glass melting plants using the standard exhaust gases in preheaters having separate guidance of exhaust gases and feed material, without gluing together or agglomeration of the feed material in the preheaters.

According to the present invention, in the method indicated above this object is achieved in that

a) the heating elements situated in the uppermost tier are closed with respect to the mixture and are maintained at temperatures of at least 100° C.,
b) the boundary surface between the bulk material of the mixture and the atmosphere above the bulk material is shaped and heated by the heating elements situated in the uppermost tier in such a way that a part of the heat energy is emitted to the atmosphere via the bulk material, and
c) as the mixture proceeds through the container, additional heating elements bring the mixture to temperatures close to the feed temperature for the glass melting plant.

Through this solution, it is achieved that the feed material of glass melting plants is heated using the standard exhaust gases in preheaters having separate guidance of exhaust gases and feed material, without gluing together or agglomeration of the feed material in the pre-heaters. Moisture that is carried along is largely driven out upward from the container, from the beginning onward, and also cannot penetrate into the exhaust gas of the oven heating. This also holds for example for rainwater or wash water carried along by glass fragments. In particular, the previously standard column of feed material above the uppermost heating elements is avoided, which also encouraged gluing together due to gravitational forces.

In further embodiments of the method, it is particularly advantageous if, either individually or in combination:
at least the predominant part of the boundary surface is held under a virtual horizontal enveloping surface that contacts the heating elements at their upper sides,
the mixture is brought into the region of the uppermost heating elements and is maintained in a flowable state through movement in a temperature range between 30° C. and 100° C.,
the mixture is in this way distributed over a surface that corresponds at least approximately to the entire available cross-sectional surface of the container,
the mixture is conducted through a tiered configuration of polygonal heating elements,
the charging process for the mixture is controlled by a sensor whose action is directed onto the free surface of the mixture inside the container,
the process of emptying the container is controlled by a dosage device,
the mixture is conducted by an inner bearer in which the heating elements are mounted rigidly and so as to be sealed, the inner bearer being set into vibration relative to the container by a vibrator,
the mixture is first dosed into a storage silo, from which it is drawn into the container via a dosage device for dewatering and heating,
the dosage device of the storage silo is controlled by the sensor for the feeding of the container,
exhaust gases from heating areas of the glass melt plant are conducted through the heating elements, and/or
the exhaust gases flow through the heating elements in opposite directions in at least a portion of the tiers.

The present invention also relates to a device for the thermal dewatering and preheating of aqueous mixtures for feeding glass melting plants when conducted through a shaft-type container provided with heating elements disposed one over the other in tiers for the supply of heat.

In order to achieve the same object and the same advantages, such a device is characterized in that

a) at least the heating elements situated in the uppermost tier are fashioned so as to be closed at their circumference, and
b) are situated with their cross-sectional surfaces in a horizontal plane that intersects a constructively determined boundary surface between the mixture and the atmosphere above the mixture, and that
c) with a part of their surfaces, these uppermost heating elements stand in thermal contact with, in addition to the mixture, the atmosphere above the mixture.

In further embodiments of the device, it is particularly advantageous if, either individually or in combination:
the uppermost heating elements are connected to a regulator for the maintenance of temperatures between 30° C. and 100° C.,
a part of the heating elements situated in the subsequent tiers is fashioned so as to be downwardly open at its circumference,
at least the heating elements of the upper tiers have a polygonal cross-section,
the longest axes of this cross-section are oriented vertically,
the heating elements of lower tiers have a roof-shaped cross section and are downwardly open,
above the uppermost tier of heating elements there is situated a sensor by which the charging process for the mixture can be controlled,
a dosage device is situated at the lower end of the container, for the emptying process,
in the container there is situated an inner bearer in which the heating elements are mounted rigidly and so as to be sealed, and the inner bearer is connected to a vibrator by which the heating elements can be set into vibration relative to the container,
the inner bearer is suspended on a horizontal cross beam that is supported on springs at both ends,
over the container there is situated a storage silo into which the mixture can be dosed and from which it can be drawn, via a dosage device, into the container for dewatering and heating,
the dosage device of the storage silo can be controlled by a sensor for the feeding of the container,
the heating elements are connected to exhaust gas lines of the glass melting plant for the conducting of exhaust gases from heating areas of the glass melting plant, and/or
a plurality of housings are situated one over the other in a modular construction.

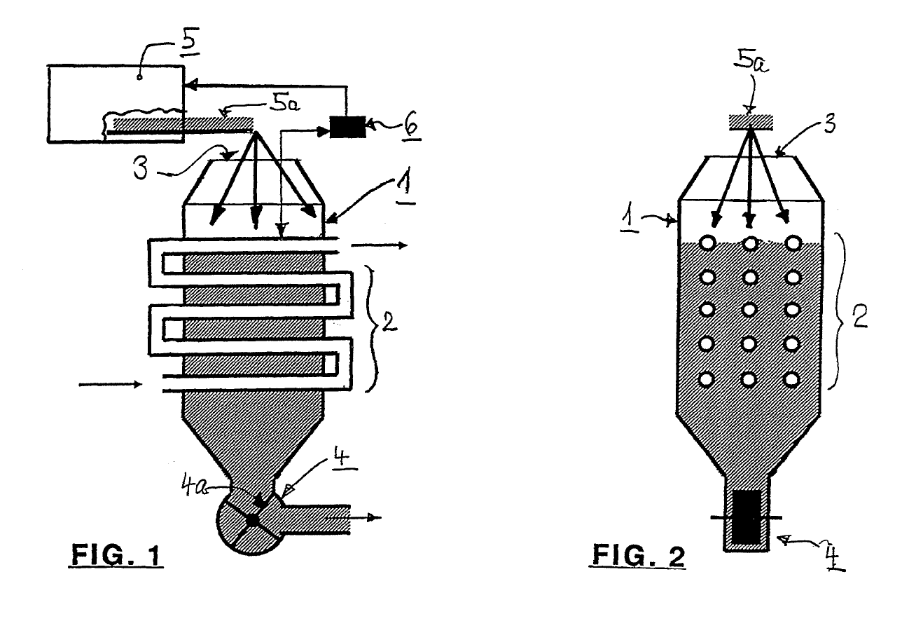

Exemplary embodiments and further developments of the subject matter of the present invention, and the operation and further advantages thereof, are explained in more detail in the following on the basis of the schematic FIGS. 1 through 12.

FIG. 1 shows a section through a container having a mixture along a vertical midplane in which the axes of a plurality of horizontal heating elements run,

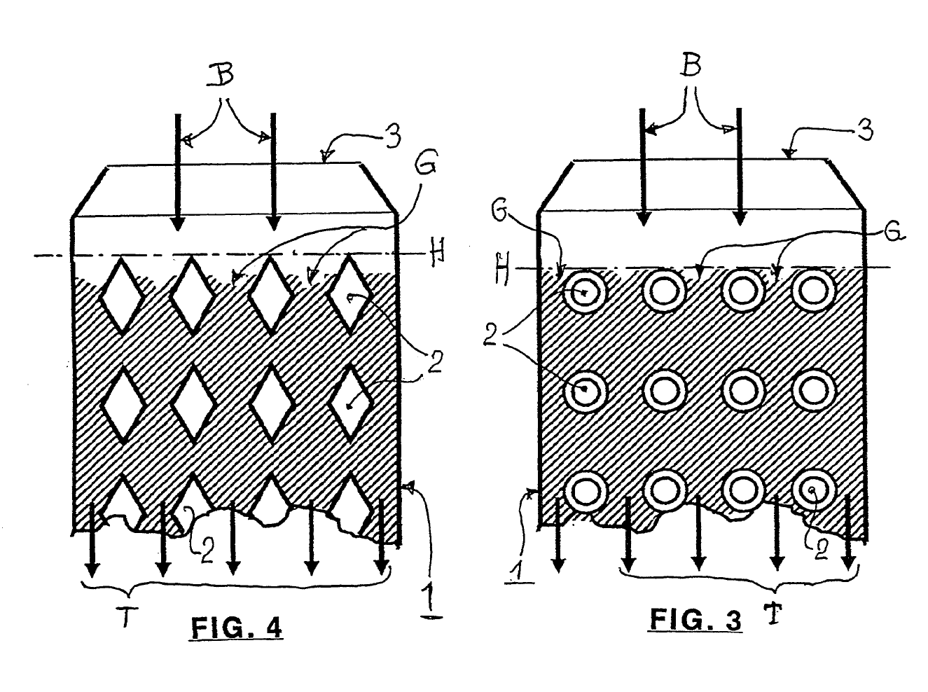

FIG. 2 shows a section along a vertical midplane that is oriented perpendicular to that shown in FIG. 1,

FIG. 3 shows an enlarged representation analogous to FIG. 2, in which additional geometries and functions in the environment of cylindrical heating elements are shown,

FIG. 4 shows a representation analogous to FIG. 3, in which additional geometries and functions in the environment of rhombic heating elements are shown,

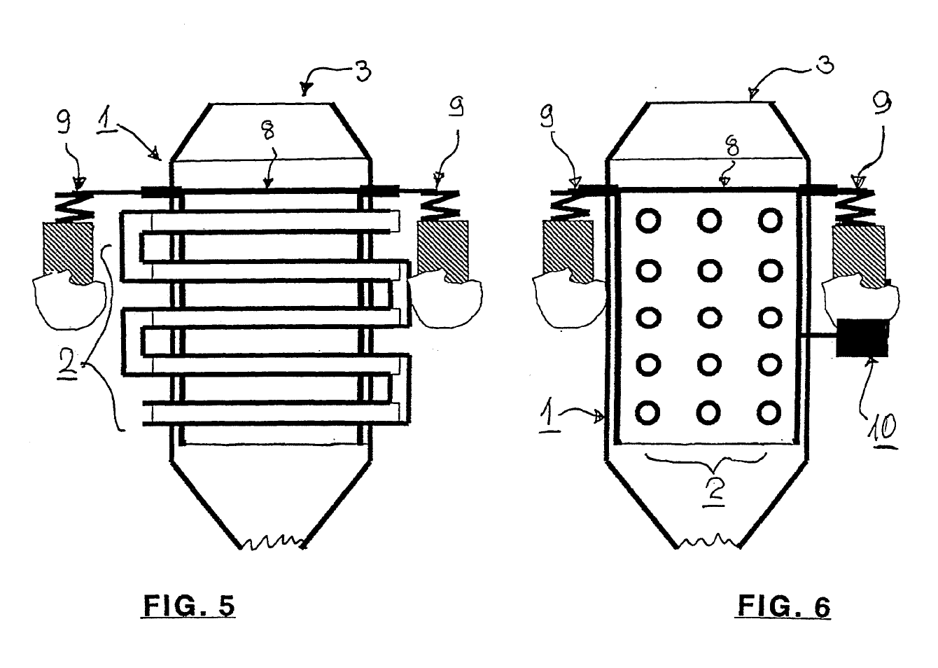

FIG. 5 shows a further development according to FIG. 1 without mixture, in which the heating elements are mounted in analogous spatial position in a movable inner bearer,

FIG. 6 shows a section analogous to FIG. 5 at a right angle thereto,

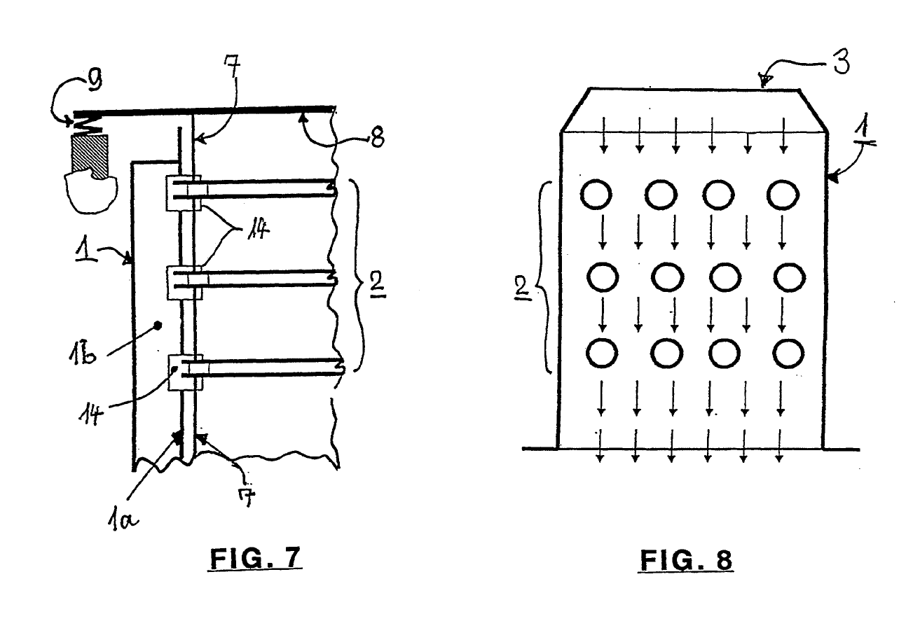

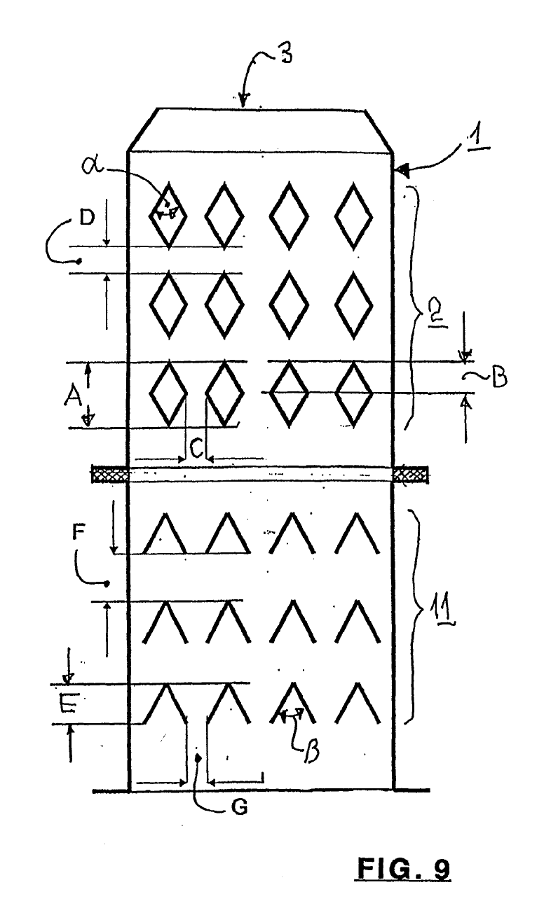

FIG. 7 shows an enlarged detail from FIG. 5, showing additional details,

FIG. 8 shows the flow paths in the upper part of a container not filled with mixture,

FIG. 9 shows various cross-sectional shapes of heating elements,

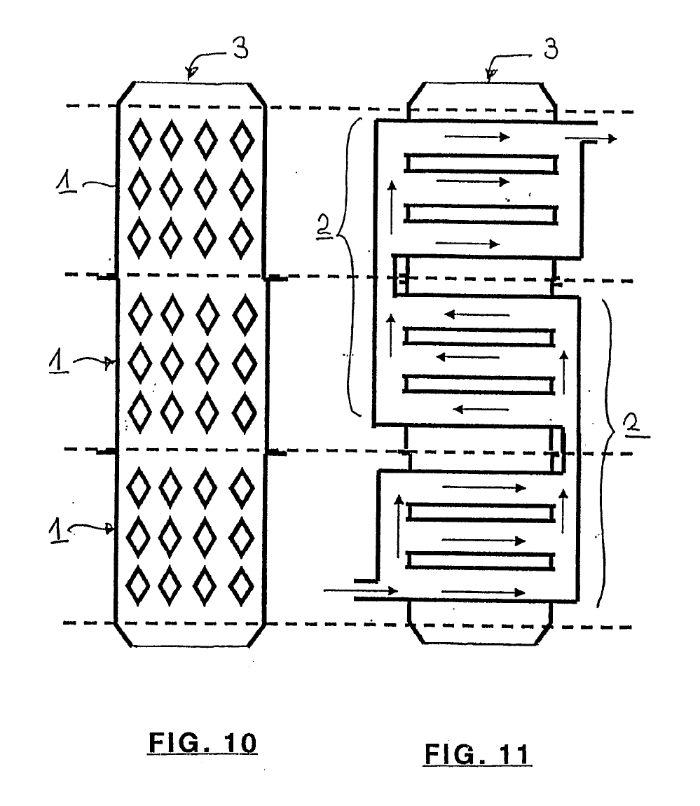

FIG. 10 shows a modular configuration of three containers placed one on the other, according to the upper part of FIG. 9,

FIG. 11 shows a vertical section through the device shown in FIG. 10, at a right angle thereto, and

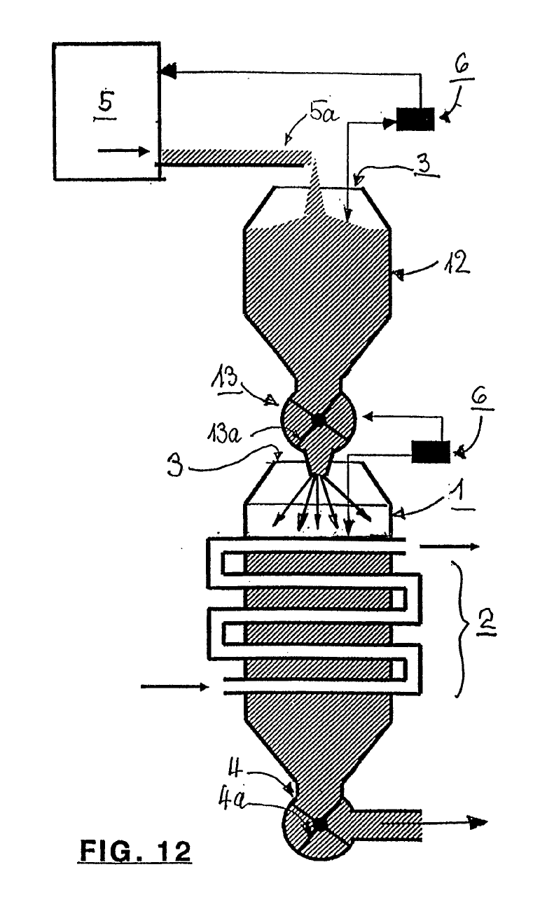

FIG. 12 shows a combination of FIG. 1 with a storage silo placed thereon.

FIG. 1 shows a section through a shaft-shaped container 1 along its vertical midplane, in which there run the axes of a plurality of horizontal heating elements 2, which, in the form of meanders, are connected to one another by U-shaped connecting pieces. As is shown in FIGS. 1 and 2, heating elements 2 form a three-dimensional structure in which in each case three heating elements are situated one over the other in five tiers, in the form of grids. At the upper end, container 1 has a feed opening 3, and at its lower end it has a dosage device 4 having a cellular wheel 4a. Subsequently, the feed material is supplied to a glass melting plant, which is not shown here. The horizontal cross-section of container 1 may be made cylindrical, but may also be made polygonal, for example in the shape of a square or rectangle.

Above feed opening 3 there is situated a charging device 5 having a discharge element 5a whose conveying rate is controlled by a sensor 6. Here the following is important: the gluing together of the feed material is prevented in that this material is applied over the uppermost tier of heating elements 2, in the largest cross-sectional surface thereof, up to container 1, the maximum extent of the application being only up to the uppermost lines of each of the uppermost heating elements 2. In this way it is ensured that the particles of the feed material, during its downward movement in the critical temperature range between 30° C. and 100° C., are kept in constant movement relative to one another. The feed material can advantageously also contain glass fragments, preferably limited to a maximum of 50% by weight. Further details are explained below on the basis of FIGS. 3 and 4.

Sensor 6 can be supplied with the following signals: known are mechanical and piezoelectric filling level sensors, and sensors that operate on the basis of a radar measurement. Depending on the setting of the upper and lower limits for these measurements, charging device 5 is commanded either to operation or to terminate the charging.

On the basis of FIGS. 3 and 4, the functional relationships with the geometrical device elements are explained in more detail, FIG. 3 showing heating elements 2 having circular cross-section, and FIG. 4 showing heating elements having rhombic cross-section. The feed material is represented by coarse hatching for the sake of simplicity.

Boundary surfaces G show surface profiles between the bulk material of the feed material, fed in the direction of upper arrows B, and the gas or vapor atmosphere thereabove. The feeding can take place in stationary fashion or through alternating transverse movements of charging device 5. The uppermost lines of the heating elements lie in a virtual horizontal and planar enveloping surface H, and boundary surface G is situated thereunder. This illustrates the relative spatial position of the uppermost particles or granulates of the feed material, which is specified in the direction of arrows T by a prespecified ratio of feed quantity and drawn-off quantity per time unit, and also constructively by regulating mechanisms.

The mixture first flows in the transverse direction, from the uppermost surface elements or edges of heating elements 2, and produces a shaping and possibly also an interruption of boundary surface G. This shaping, and the resulting relative position of boundary surface G to enveloping surface H is the precondition for the fact that the upper partial surfaces of all upper heating elements 2 are able to emit a part of their overall heat contribution into the gas or vapor atmosphere of container 1 by convection. The consequence is that water vapor is kept from penetrating into the mixture, and that water vapor that could be carried along by the mixture rises up.

FIGS. 5 and 6 show a further development of the subject matter of FIGS. 1 and 2, in which heating elements 2 are mounted in analogous spatial position in an inner bearer 7. This bearer is suspended, with radial distances, on a stable cross beam 8 in container 1, and is downwardly open. Cross beam 8 is supported at both ends on springs 9. According to FIG. 6, inner bearer 7, and with it heating elements 2, are connected to a vibrator 10 by which the grid structure of all heating elements 2 can be set into vibration. The vibration frequency can be selected between 500 and 3000 Hz, and also further counteracts the gluing together.

Continuing the foregoing numbering, FIG. 7 shows an enlarged detail from FIG. 5, showing additional details. Heating elements 2 are connected fixedly and in gas-tight fashion to cage 7, but, by means of elastic sealing elements 14, are guided through an additional inner wall 1a of container 1 elastically and so as to be gas-tight and tight against dust. Intermediate space 1b provides a parallel and uniform supply of heating gas from the oven to heating elements 2.

FIG. 8 shows the flow paths, indicated by arrows, for the feed material in the upper part of a container 1, here not filled with mixture. In contrast, FIG. 9 shows various cross-sectional shapes of heating elements 2 and 11. In the upper region, heating elements 2 have a closed rhombic cross-section in which the longest axes of symmetry run vertically. In this way, heating elements 2 have the dissipating effect of roofs. They are closed at the circumference in order to prevent water vapor from the combustion gases from entering into the feed material there. The following dimensions have proven suitable:

### A=100 to 400 mm

### B=50 to 400 mm

### C=50 to 400 mm

### D=50 to 400 mm

α=20 to 40 degrees (so-called roof angle)

In the lower region, in which there is no danger of gluing together, heating elements 11 can be downwardly open. The following dimensions have proven suitable:

### E=50 to 250 mm

### F=50 to 400 mm

### G=50 to 400 mm

β=20 to 40 degrees (so-called roof angle)

The number is determined by the size of container 1.

FIGS. 10 and 11 show a modular configuration of three containers 1 placed on one another, according to the upper part of FIG. 9. FIG. 11 shows a vertical section through the device shown in FIG. 10, at a right angle thereto. The guiding of the heating gases alternates after flowing through each three tiers, each having 12 heating elements 2 closed at the circumference, as indicated by arrows. The uppermost module contains the so-called drying area, and the two lower modules are used for the preheating to the feed temperature of the following glass melting oven.

Again continuing the previous reference character numbering, FIG. 12 shows a combination of FIG. 1 with a storage silo 12 placed thereon. This silo is analogously fed, as shown in FIG. 1 above, from a charging device 5 having a discharge element 5a, likewise controlled by a sensor 6, but with a different time sequence. Thus, storage silo 12 can be fed at temporal intervals of up to some hours. Storage silo 12 likewise has at its lower end a dosage device 13 having a cellular wheel 13a. This wheel is also regulated by a sensor 6, in a manner analogous to the subject matter of FIGS. 1 and 2. A preheating of the mixture can also already be carried out in storage silo 12.

An essential element of the present invention is the extremely thin layer of the mixture distributed over a large cross-sectional surface in the region of the uppermost heating elements. The following drying area can, depending on the size of the device, extend to a depth of from 0.2 m to 0.5 m. There then follows the further heating to the charging temperature for the melting oven. The stated cross-sectional surface extends over the entire inner cross-section of container 1.

### Exemplary Embodiment

At a production quantity of 300 tons of glass per day, there is a raw material requirement of 326 tons per day with an addition of fragments of 50%. The raw mixture requirement is 176 tons per day. The content of storage silo 12 here is 150 tons, and its feeding takes place every two hours. The decrease in the silo contents after two hours is 27 tons, and the bulk density of the raw materials is 1.1 tons/m³. The height of the silo is 13 m, and its base surface is 10 m². After two hours, the decrease in the filling level in the silo is 2.5 m.

Storage silo 12 can also be designated a “buffer silo,” and its capacity can be reduced for example to 50 tons. The feeding then takes place every two hours, after a decrease in the content of 27 tons.

The particles of the mixture can be agglomerates and/or granulates. The agglomerates are a technically produced balling together of individual grains. In general, the granulates are a powdered, easily pourable solid material.

Successful mixture: Initial weight 1500 kg.

| Component | Formula | Portion in wt. % |
|---|---|---|
| Quartz sand | SiO₂ | 57.221 |
| Sodium carbonate | Na₂CO₃ | 18.282 |
| Feldspar 900S | Na₂OAl₂O₃6SiO₂ | 5.667 |
| Limestone | Ca₂O3₂ | 4.022 |
| Dolomite | CaCO₃MgCO₃ | 14.260 |
| Sodium sulfate | Na₂SO₄ | 0.548 |

### LIST OF REFERENCE CHARACTERS

1 container
1a inner wall
1b intermediate space
2 heating elements
3 feed opening
4 dosage device
4a cellular wheel
5 charging device
5a discharge element
6 sensor
7 inner bearer
8 cross beam
9 springs
10 vibrator
11 heating elements
12 storage silo
13 dosage device
13a cellular wheel
14 sealing elements
B arrows
G boundary surface
H enveloping surface
T arrows

1-26. (canceled)

27. A method for the thermal dewatering and preheating of an aqueous mixture including a bulk material for feeding a glass melting plant when the mixture is conducted through a shaft-type container provided with heating elements situated one over the other in tiers for supplying heat, comprising the steps:
a) maintaining the heating elements in an uppermost tier, which are closed with respect to the mixture, at temperatures of at least 100° C.,
b) shaping and heating a boundary surface between the bulk material of the mixture and the atmosphere above the bulk material by the heating elements situated in the uppermost tier in such a way that a part of the heat energy is emitted to the atmosphere via the bulk material, and
c) as the mixture proceeds through the container, utilizing additional heating elements to bring the mixture to temperatures close to a feed temperature for the glass melting plant.

28. The method as recited in claim 27, including the step of holding at least a predominant portion of the boundary surface below a virtual horizontal enveloping surface that contacts the heating elements at their upper sides.

29. The method as recited in claim 27, including the steps of applying the mixture in the region of the uppermost heating elements and maintaining the mixture in a flowable state by movement of the mixture in a temperature range of between 30° C. and 100° C.

30. The method as recited in claim 27, including the step of distributing the mixture over a surface that corresponds at least approximately to a total available cross-sectional surface of the container.

31. The method as recited in claim 27, including the step of conducting the mixture through a tiered configuration of pipe-shaped heating elements.

32. The method as recited in claim 27, including the step of controlling the charging process for the mixture by a sensor whose action is directed onto the free surface of the mixture inside the container.

33. The method as recited in claim 27, including the step of controlling the emptying of the container by a dosage device.

34. The method as recited in claim 27, including the steps of conducting the mixture through an inner bearer in which the heating elements are mounted rigidly and so as to be sealed, and setting the inner bearer into vibration relative to the container by a vibrator.

35. The method as recited in claim 27, including the step of first dosing the mixture into a storage silo, and subsequently drawing the mixture, via a dosing device, into the container for dewatering and heating.

36. The method as recited in claim 35, including the step of controlling the dosing device of the storage silo by a sensor for the feeding of the container.

37. The method as recited in claim 27, including the step of conducting exhaust gases from heating areas of the glass melting oven through the heating elements.

38. The method as recited in claim 27, including the step of flowing the exhaust gases through the heating elements in opposite directions in at least a part of the tiers.

39. A device for thermal dewatering and preheating of aqueous mixture for feeding glass melting plants when the mixture is conducted through a shaft-type container that is provided with heating elements situated one over the other in tiers for supplying heat, comprising
a) at least the heating elements situated in an uppermost tier are constructed so as to be sealed at their circumference,
b) the heating elements situated in the uppermost tier are situated with their outer-surfaces being in a horizontal plane that intersects a constructively determined boundary surface between the mixture and an atmosphere above the mixture, and
c) with a part of their surfaces, the uppermost heating elements stand in thermal contact with, in addition to the mixture, the atmosphere above the mixture.

40. The device as recited in claim 39, wherein the uppermost heating elements are connected to a regulator for maintaining temperatures between 30° C. and 100° C.

41. The device as recited in claim 39, wherein a part of the heating elements situated in the subsequent lower tiers are fashioned so as to be downwardly open at their circumference.

42. The device as recited in claim 39, wherein at least the heating elements of the upper tiers have a polygonal cross-section.

43. The device as recited in claim 42, wherein the longest axes of the polygonal cross-section are oriented vertically.

44. The device as recited in claim 39, wherein the heating elements of lower tiers have a roof-shaped cross section and are downwardly open.

45. The device as recited in claim 39, wherein above the uppermost tier of the heating elements there is situated a sensor by means of which the charging process for the mixture is controlled.

46. The device as recited in claim 39, wherein a dosage device is situated at a lower end of the container for an emptying process for the container.

47. The device as recited in claim 39, wherein in the container there is situated an inner bearer in which the heating elements are mounted rigidly and so as to be sealed, and that the inner bearer is connected to a vibrator by means of which the heating elements can be set into vibration relative to the container.

48. The device as recited in claim 47, wherein the inner bearer is suspended on a horizontal cross beam that is supported on springs at both ends.

49. The device as recited in claim 39, wherein above the container there is situated a storage silo into which the mixture is dosed, and from which the mixture is drawn, via a dosage device, into the container for dewatering and heating.

50. The device as recited in claim 49, wherein the dosage device of the storage silo is controlled by a sensor for the feeding of the container.

51. The device as recited in claim 39, wherein the heating elements are connected to exhaust gas lines of the glass melting plant for conducting exhaust gases from heating areas of the glass melting plant.

52. The device as recited in claim 39, wherein a plurality of housings are situated one over the other in a modular construction.
